(19) United States
(12) Patent Application Publication
(10) Pub. No.: US 2026/0341541 A1
(43) Pub. Date: Oct. 29, 2026

(54) BOILING FUEL FAST NEUTRON NUCLEAR REACTOR

(71) Applicant: Maoz BETSER-ZILEVITCH, Calgary, Alberta (CA)

(72) Inventor: Maoz BETSER-ZILEVITCH, Calgary, Alberta (CA)

(21) Appl. No.: 19/231,444

(22) Filed: Jun. 7, 2025

(30) Foreign Application Priority Data
Feb. 26, 2025 (CA) 3266178

(51) Int. Cl. G21C 1/02; G21C 3/04; G21C 3/24; G21C 3/54; G21C 7/02; G21C 7/22; G21C 19/303

(52) U.S. Cl. CPC G21C 1/026; G21C 3/041; G21C 3/24; G21C 3/54; G21C 7/02; G21C 7/22; G21C 19/303

(57) ABSTRACT

The method and a system for a self-regulated, temperature-controlled fast neutron reactor are based on the fuel boiling chemical behavior. The reactor maintains the fuel boiling temperature independent from the extracted heat. As such, it is inherently safe to operate and can naturally adjust the nuclear reactivity and heat production to the extracted heat. In one embodiment, the reactor includes multiple internal elongated enclosures, which become active and approach criticality when they are partly filled with fissionable uranium and plutonium liquid salt. The core reactivity and temperature are controlled by the uranium and plutonium liquid salt expansion and boiling, maintaining the core reactivity and maximum temperature, which will balance the fuel evaporation temperature.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a nuclear reactor.

### 2. Description of Related Art Including Information Disclosed Under 37 CFR 1.97 and 37 CFR 1.98

The current invention is a temperature-self-controlled, fast nuclear reactor. The fast reactor, referred to as a “breeder” fast reactor, includes a nuclear reactor capable of generating more fissile nuclear fuel than it consumes. In these reactors, the neutron economy is high enough to breed more fissile nuclear fuel (e.g., plutonium-239, Uranium 233, etc.) from fertile nuclear reactor fuel (e.g., uranium-238 and thorium) than it burns in a fission reaction. In principle, a breed-and-bum reactor may approach an energy extraction rate of 100% of the fertile materials, which is the most efficient way to tap into and extract the energy from the cosmic events that created the heavy elements on earth. To initiate the breeding process, a breed-and-bum reactor must first be fed with fissile fuel, such as enriched uranium 235, plutonium, Uranium 233, etc.’. After that, breed-and-bum reactors may sustain energy production over decades without refuelling. Another advantage of the fast neutron reactor is the nuclear waste compared to the moderated slow reactors. Due to its efficiency and low energy intensity, the reactor will “burn” the long half-life of nuclear waste, thereby minimizing nuclear waste storage requirements by an order of magnitude.

Given the advantages of the fast neutron reactor, it will be used in place of or in conjunction with moderated thermal reactors.

U.S. Pat. No. 11,365,060B2 , entitled “Conveyor Module, Assembly, System, and Control,” issued to Michael C. McElligott on Jun. 21, 2022, is incorporated by reference herein.

### BRIEF SUMMARY OF THE INVENTION

The current invention is a method and a system for a self-regulated, temperature-controlled fast neutron reactor based on the fuel boiling chemical behaviour. The reactor is designed to maintain the fuel boiling temperature independent from the extracted heat. As such, it is inherently safe to operate and can naturally adjust the nuclear reactivity and heat production to the extracted heat. In one embodiment, the reactor comprises multiple internal elongated enclosures, which become active and approach criticality when they are partly filled with fissionable uranium and plutonium liquid salt. The core reactivity and temperature are controlled by the uranium and plutonium liquid salt expansion and boiling, maintaining the core reactivity and maximum temperature, which will balance the fuel evaporation temperature. A heat transfer liquid flows around the multiple internal elongated enclosures. The multiple internal elongated enclosures are located in a reflecting and possibly futile breeding surrounding. The fuel vapour in the internal elongated enclosures can expand by further fuel boiling or contract by condensation back to the liquid stage. The heat transfer liquid can be molten salt, including breeding elements like thorium and U238. The partly filled enclosures in the reactor can change their liquid fill level. As the fissionable fuel liquid phase (and not the gas phase) is the main contributor to the physical structure criticality, the ability of the reactor to have a wide range of liquid fill levels contributes to the operation flexibility, allowing the reactor to become critical with a wide range of enrichment fuel and a wide range of contamination and neutron poisons. By increasing the liquid fill level, the reactor will increase its reactivity. The liquid level is also naturally controlled by the reactor temperature, which is controlled by the liquid evaporation temperature. All are naturally controlled based on the basic fuel salt chemistry that dictates the evaporation temperature, which will dictate the reactor working temperature, and the fuel level will be naturally maintained at that level. This is an advantage over using an external control system with moving parts (like control rods) normally used to control reactors. This continuous change in the reactor geometries controls the reactivity, as the increase in the fissionable molten salt fill level changes the geometry related to the reactor reactivity. In addition, the reactor can work on a large variety of loads because the temperature of the core is constant based on the fuel evaporation temperature, the amount of heat will be changed substantially by increasing the coolant flow as the reactor will react to the higher cooling demand to maintain it's temperature by an increase of the fission salt level and vice versa when the required heat production demand goes down. This reactivity change is done automatically by the reactor based on the basic evaporation and condensation properties of the molten fuel salt. The selection of the molten salt fuel will dictate the temperature within the reactor enclosures, which will be the saturated evaporation temperature of the molten salt.

Another option is to use a liquid reflector and breeding zone around the reactive core. The reactor includes multiple internal elongated enclosures partially filled with enriched molten Uranium or plutonium salts. The salt can include any halogen Fluoride, Chloride, Bromide, or Iodine. Fluoride and Chloride salts are preferred based on existing knowledge. The reactor will operate at low pressures, close to the atmospheric pressure. This is possible mainly due to the high temperatures, which allow high power generation efficiency and high-pressure, super-heated steam production. The high temperature and intense radiation limit the materials used to construct the reactor structure that can withstand pressure, which in this reactor is not required due to the lower mechanical stress due to the low operating pressure.

In addition, the low pressure increases the reactor's inherent safety by minimizing the risk of explosion. The reactor's reactivity is based on the reactor structure, the fuel reactivity, the molten salt expansion, boiling, and evaporation temperature. The reactor control is based on the evaporation-condensation balance of the fissionable fuel. The evaporated salt will reduce the liquid level and the criticality mass, so the elongated enclosures containing the fuel within the core will maintain the evaporation-condensation temperature. Because the generated heat is transferred through the elongated enclosures within the core, there is a need to reduce the maximum operation temperature to allow the use of various materials, including alloys, that can maintain the temperature and the radiation levels. The fuel salt selection will achieve this. For example, for using Uranium tetrachloride UCl4 salt, the boiling temperature of this salt is around 790 C, preventing the temperature from exceeding this temperature. This temperature is sufficiently low to allow the use of special alloys. In the past, with chloride molten salt reactors, the preferred uranium salt was UCl3 due to its higher evaporation temperature, as the designs kept the fissionable fuel in a liquid state to prevent evaporation. Heat is recovered from the elongated enclosures (tubes, for example) by a flowing liquid around them. The liquid can be a molten metal like sodium, lead, Bismuth, or molten salt. The flowing molten salt can serve as a reflector and breeding element if it includes U238 or thorium salts. The fast neutron reaction will generate fissionable plutonium fuel from the non-fissionable U238 or fissionable U233 from the non-fissionable thorium while generating additional heat in the process.

Because the saturated evaporation-condensation controls the reactor's maximum temperature, it can adjust the heat production to the demand. Even if the heat demand drops, the maximum core temperature will not exceed the evaporation temperature. Due to the potentially small size, low pressure, control simplicity, and inherent safety of the reactor, it can be modularized into pre-built elements. It can also supply steam and heat to remote locations, such as steam for oil recovery, like the SAGD. Due to the reactor's simplicity and low pressure (as it self-controls its temperature and can adjust to different and changing fuel reactivity), it can operate for a long duration without fuel reprocessing and can be constructed in a smaller size, allowing it to be modularized.

### BRIEF DESCRIPTION OF THE SEVERAL VIEWS OF THE DRAWINGS

FIGS. 1-9 are schematic views of embodiments of the present invention.

### DETAILED DESCRIPTION OF THE INVENTION

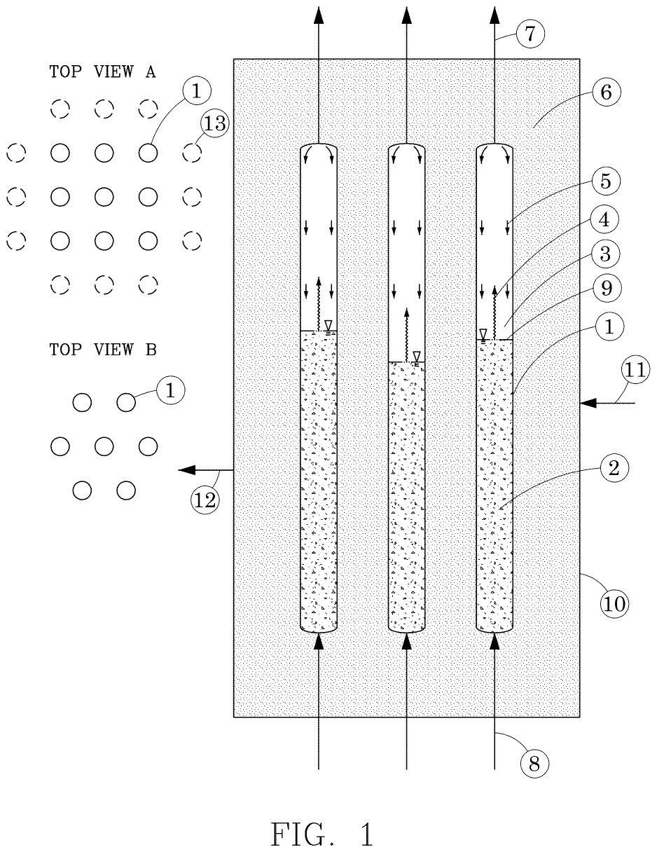

FIG. 1 shows an embodiment of the invention.

A nuclear reactor contains multiple elongated internals 1. The internals can be in a vertical tube shape. Each interval includes a liquid phase 2 and a gas phase 3. The liquid phase level 9 can change going up (increasing the amount of the liquid) or down (decreasing the amount of the liquid). The criticality is maintained by the combined tubes, which are arranged close to each other so the electron from the fission reaction in one of the tubes can travel and reflect into an adjusted tube, similar to how the fuel rods are arranged in a typical reactor as can be seen in top view A and top view B.

The liquid volume contains the nuclear fuel in a liquid form of molten salt. The fissile nuclear fuel contains at least one of Uranium 235, Uranium 233, and Plutonium in a halogen salt chemical composition. It will be preferred to use a chlorine-based molten salt or fluorine-based molten salt due to their properties and the experience gained in the past with the chlorine and fluoride salts, their production and the structural material that can be used.

The temperature of the liquid salt fuel is maintained by evaporation of the fuel 4. The liquid level 9 is based on the reactivity of the fuel and the core physical structure. For more reactive fuel with less parasitic neutron poison and closer longitude enclosures 1 with an efficient electron reflector, a lower liquid volume will be maintained so that the fuel evaporation will self-control the chain reaction. The reactor pressure is relatively low, close to atmospheric pressure and gas and fuel vapour can leave the enclosure to prevent overpressure, to condense the salt vapour and remove contaminants. The fissile uranium 2 also contains Uranium 238, which will undergo fast neutron nuclear reactions to generate additional fissionable fuel, mainly plutonium. The reactor's working temperature is based on the chemical properties of the nuclear fuel and Halogen salts. The temperature is the saturated evaporation and condensing liquid salt temperature where the fuel salt gas 3 and liquid phases 2 are in equilibrium at the given pressure. For example, if the fuel includes fissionable UF4, the reactor's core center temperature will be controlled by the evaporation temperature of this salt, which is about 1417 C. This high temperature limits the structural materials that can be used for the elongated enclosure tube 1. If, for example, fissionable UCl4 salt is used, the reactor temperature will be controlled by the evaporation temperature of the Uranium IV Chloride, which is a much lower reactor temperature as the boiling temperature of UCl4 is around 791 C. If fissionable uranium pentafluoride, UF5, is used as a fuel, the reactor work temperature will be even lower, as the boiling temperature of UF5 is around 530 C, while the freezing temperature will be 349 C. This makes this material attractive for use as fuel in the proposed invention, as the 530 C temperature allows the use of various structure materials and well-known alloys. It is also possible to raise the 530 C evaporation temperature as needed as the boiling temperature also depends on the fuel salt eutectic mixture as other components (like NaF, LiF, ZrF4, Kf and others) can increase the boiling temperature to achieve different (higher) boiling temperatures as preferred by the reactor design.

The evaporated fissionable nuclear fuel 4 fills portion 3 of the elongated enclosure 1. Gases and vapours can leave the elongated enclosure from its top 7, prevent overpressure, and remove generated NCG (non-condensable gases) accumulating in fuel enclosure 1. The evaporated fuel condensed 5 on the enclosure wall, transferring its condensation heat to the enclosure 1 wall. This condensation will maintain the enclosure wall temperature due to the salt condensation temperature, transferring heat through wall 1 to the reactor heat transfer fluid 6. When the molten salt vapour 3 condenses to liquid 5 on the enclosure wall, its volume substantially reduces, increasing the liquid level by turning into concentrated liquid and allowing additional liquid 8 to flow into the enclosure to replace the volume of the condensed salt. This will increase the reactor's reactivity and heat generation. The internal pressure within the elongated enclosure tubes is relatively low and is regulated by the generation of molten salt fuel vapour enclosure pressure and is controlled by the vapor discharge 7. The enclosure is surrounded by a heat transfer fluid 6. The heat transfer fluid can be used as a reflector and a breeder and is selected to be compatible with the fuel 2. For example, if fuel 2 includes fissionable Uranium pentafluoride UF5, the working temperature of the fuel tubes 1 will be relatively low due to the evaporation temperature of the UF5, which is around 530 C. Because other salts can be added to the UF5, the evaporation can be higher than the evaporation temperature of the pure UF5 salt, which will increase the reactor tubes 1 temperature. The heat transfer fluid 6 can include non-fissionable (U238) Uranium pentafluoride UF5, as well as non-fissionable UF4 and thorium fluoride in a mixture with other molten salts to achieve low melting point and flowability for the surrounding liquid 6. Possible molten salts include Tin (II) fluoride SnF2, sodium fluoride, zirconium fluoride, lithium Fluoride, beryllium fluoride and other fluorides. Another option is to use molten metals like Sodium, lead, and bismuth as the heat transfer fluid. In that option, breeding additional plutonium fuel will happen only within the fissionable tubes (as it includes U238 and possibly Thorium) and not within the heat transfer and reflector liquid metal 6. For another example, if fuel 2 includes fissionable Uranium Tetrachloride UCl4, the working temperature of the fuel tubes 1 will be controlled based on the evaporation temperature of the UCl4, which is, according to the literature, around 760 C-791 C. The heat transfer fluid 6 can include non-fissionable (U238) Uranium tetrachloride UCl4, as well as non-fissionable UCl3 and thorium chloride in a mixture with other molten salts to achieve low melting point and flowability for the surrounding liquid 6. Possible molten salts include sodium chloride, Magnesium chloride, and other chlorides in a eutectic mixture. It is also possible to use a fluoride salt mixture with a chloride fuel salt mixture within the tubes, as there is no mixture between them.

Heat is recovered from the reactor enclosure 10 by circulating liquid 6 through an external heat exchanger (not shown). The fluid 11 is pumped through the reactor fuel elongated tubes 1 and collects heat generated within the enclosure and heat from intense radiation. The surrounded circulated fluid 6 is heated and leaves enclosure 12, transferring a portion of its heat through heat exchange. The recovered heat can be used for any useful purpose, mainly to generate electric energy.

Fissionable fuel 8, 2 mainly includes fissionable Uranium, plutonium isotopes, and other Actinides. The fuel metals are chemically reacted with halogens to produce salts. The evaporating temperature of the fuel salt is controlling the reactor temperature. The fissionable fuel salts can include fertile/breedable salts of U 238 or Thorium, which also react with the halogens. The fertile salts generate additional fissile material (additional fissile plutonium or uranium) and act as neutron reflectors. The salts can be in a eutectic mixture to reduce the liquid fuel's melting point and control the core's reactivity. In contrast to the enclosure 1 internal fissionable Uranium and Plutonium elements 2, which at least a portion evaporates, the surrounding Breedable/fertile/reflector Uranium 238 or Thorium elements 6 are maintained in a liquid state.

Another consideration for a Fertile/reflector non-fissionable salt mixture option is the melting point of the Fertile/reflector salt mixture 6, 11, 12: the melting point should be equal to or lower than the evaporation temperature of the fissionable salt 2. It is possible to reduce the melting point, control the reactivity, and increase the volume and heat transfer efficiency by adding passive salts. Reducing the melting point substantially is possible using an eutectic salt mixture. Similar to the Uranium238 and Thorium fertile salts, the evaporation point of the passive salts mixture should be similar to or higher than the evaporation temperature of the fissionable fuel salts mixture to maintain it in a liquid state. As an example, for a fissionable U235Cl4 and/or U233Cl4 fuel salt, it is possible to use LiF salt (as it evaporates at 1676 C), NaCl (boils at 1465), NaF, ZrF 4, MgCl2, KCl and other salts.

There are many other considerations when selecting the salts (nuclear properties (neutron cross-section and isotopes), stability, corrosion, toxicity, cost, melting point, viscosity, heat transfer, enclosure failure and accidental mixture of the fuel salt 2 and the heat exchange/reflector liquid 6 and so on.

The reactor core can maintain its criticality over a large range of fuel reactivity as the amount of liquid 2 and the fill of the core up to liquid level 9 can change substantially over a wide range of fill. Over time, the composition of the fuel will change as non-fissile U238 is converted to plutonium, increasing reactivity and reducing the amount of fuel needed to maintain criticality. The liquid reactive fuel with elevated levels of plutonium (and U233 if thorium is used) can recover from the reactor through re-processing where useful fissionable elements, as well as the other “poison” elements, are removed. Because of the wide range of reactivity, the reactor will not require extensive continuous re-processing as it will be able to compensate for the change in reactivity (like the generation of parasitic/poison elements) with geometry change increasing the liquid 2 fissionable level 9 to maintain the reactivity to the heat generation.

To maintain the core structure longevity and allow the use of proven structure alloys, limiting the maximum core temperature by using fissionable fuel elements with relatively low evaporation temperatures is preferred. For the option of fluoride-based fissionable fuel UF5, its literature evaporation temperature is 530 C. In case this temperature is considered to be too low, it's possible to increase the boiling temperature to maximize the thermal efficiency (and accordingly increase the reactor core temperature) by mixing the fissionable UF5 with other salts, like UF4, ZrF4, LiF, NaF, KF and others. For this option (of the use of fissionable F5 fuel), the surrounding liquid 6 can also include U238F5 in a eutectic mixture with other salts. Using Uranium 238 or Thorium in surrounding liquid 6 will improve the breeding efficiency as plutonium (or U233 in the case of Thorium) will be produced in the surrounding of the fuel tubes 1. Another option is to use Chloride liquid salts as the heat transfer, reflecting and breeding surrounding volume 6 as there is no mixture between liquid 2 and its vapour 3 and the surrounding liquid 6. The chloride heat transfer salts 6 can include U238Cl5, U238Cl4, NaCl, LiCl, KCl, MgCl2, BiCl3, PbCl2 and others. For the option of chloride-based fissionable fuel UCl42, its literature evaporation temperature is 760 C-791 C. This fissionable U235/233 salt can be mixed with fissionable UCl5 salt with a literature melt temperature of 287 C and with other non-fissionable salts like NaCl in the eutectic mixture to reduce the melt temperature of the fuel 2. The surrounding heat-transferring fluid should allow efficient flow (low viscosity) at a temperature lower than the evaporating temperature of the fuel in the core tubes 1. Fuel 1 and the surrounding liquid 6 can include re-processed fuel with long-live radioisotopes that will be “burned” with the fast neutrons in the reactor enclosure. The reactor core that contains the fissionable fuel tubes 1 and the surrounding liquid 6 can be surrounded by an additional reflector (not shown) that can contain lead and reflect neutrons back to liquid 6. The vertical longitude enclosures 1 are arranged in close proximity to each other to reach criticality when the fissionable liquid fuel 2 reaches a certain level 9. This level depends on the enrichment of fuel 2, the nuclear properties of the surrounding heat transfer liquid 6 (neutron interaction) and the surrounding enclosure and physical structure. The top view in FIG. 1 shows the possible arrangement of the boiling fissionable fuel tubes 1. Additional tube 13 can be added to accommodate different numbers and sizes of the reactor. As a rule of thumb, increasing the number of the fuel tubes or increasing their diameter will allow for more fissionable fuel in the center of the reactor, increasing the reactivity and allowing lower fuel reactivity or a larger amount of poison before reprocessing is needed. The advantage of using a larger number of smaller diameter fuel tubes 1 over a lower number of the larger diameter fuel tubes is due to the heat transfer property between the fuel 2 and the surrounding heat transfer 6 (and possible breeding and reflecting liquid). Heat transfer liquid 6 can also include a large percentage of uranium salt similar to boiling fuel 2 but with the use of non-fissionable U238 for the surrounding molten salt 6 instead of the enriched U235 (or other enriched fissionable fuel) used for the fuel 2 in the center of the reactor core to maintain the reactivity. An advantage of the use of molten salt fuel is that in case of damage to the longitude enclosure, there will be no chemical reaction between fuel 2 and the surrounding heat transfer, reflector and breeding liquid 6 while diluting the fissional fuel with the liquid 6 and reducing the reactivity which increases the inherent safety of this low-pressure reactor and prevents a chemical reaction, fire and explosion even in a fuel container failure scenario.

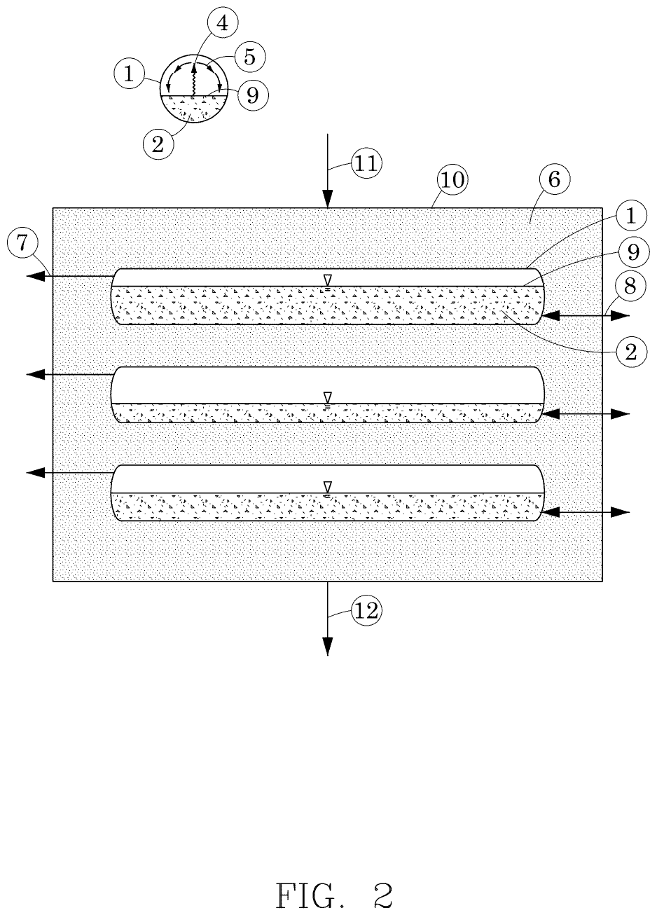

FIG. 2 shows another embodiment of the invention.

A nuclear reactor enclosure 10 contains horizontal longitude enclosure 1 partly filled with fissionable fuel liquid 2 and gas 7. The fill level depends on the reactivity of the reactor core and the heat generated. The temperature within the enclosure is maintained around the fuel evaporation and condensation temperature. Liquid fuel 2 evaporates 4 and condenses 5 within the horizontal enclosure (like a tube), where excessive vapour 7 can leave the enclosure to prevent overpressure and liquid 8 can also be pushed out of the enclosure 8 to reduce the reactivity and the temperature, which is connected to the liquid level 9 in each enclosure that can change to maintain the criticality and the heat production.

The fuel horizontal enclosure, like tubes 1 are surrounded by heat transfer liquid 6. This liquid can be a neutron reflector and breeding material to breed fission fuel from U238 halogen salt and Thorium salt. As described in FIG. 1, to allow a wide variety of structure alloys and increase the life of the internal structure, enriched uranium tetra chloride or enriched uranium pentafluoride can be used as fuel in eutectic mixture with other non-reactive salts. The surrounding liquid 6 can use uranium 238 tetrachloride and U238 pentafluoride or tetrafluoride in a liquid form of molten salt to breed plutonium and reflect neutrons. Liquid 6 can also include thorium chloride or fluoride to breed U233 and reflect neutrons. The reflecting and breeding heavy elements can be mixed in a eutectic mixture with other halogen salts with sufficiently low melting temperature and high evaporation temperature to maintain 6 in a liquid form and prevent it from evaporating. Liquid 6 flows through the reactor surrounding the horizontal enclosure 1 to recover heat. The heated fluid 12 flows to a heat exchanger to deliver the produced heat that can be used for energy generation or for any other purpose. The cooled liquid 11 is recycled back into the reactor.

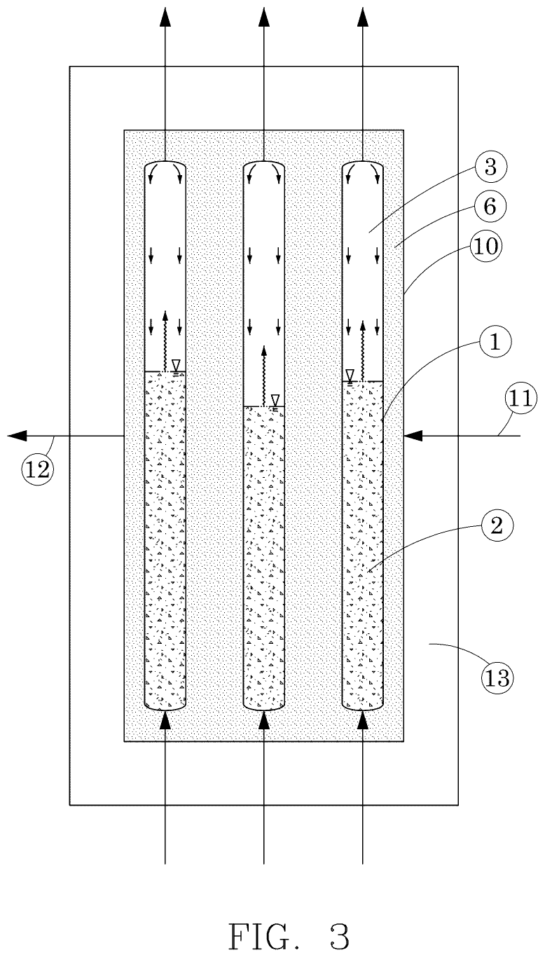

FIG. 3 shows an embodiment of the invention.

A nuclear reactor enclosure 10 contains internal enclosure 1 filled with liquid 2 fissionable fuel 2 at the bottom and vapour fissionable fuel above 3. The fuel maintains its reactivity by neutrons impacting the different enclosure fissionable fuel as each enclosure by itself does not reach criticality, but when the enclosures within the core 10 are partly filled with the molten fissional fuel salt, criticality is reached as the neutrons from one enclosure tube impacting the other tubes and vice versa. Heat transfer liquid 6 flows between the enclosure tubes to recover heat and recycled 12 to an external heat exchanger. Fluid 6 can also include U238 or thorium molten salts that reflect neutrons and bring additional fission fuel. Other liquids can be liquid lead with bismuth, that are also an effective neutron reflectors, or liquid sodium, which is not a reflective material. To enhance the reflectiveness and shielding, a reflective layer 13 is used. The reflective layer includes lead, uranium, steel, tungsten or any other heavy reflective element. The external layer can be solid or liquid. It is also possible to use a partly filled void with solid particle packing that allows the flow of liquid 6 in between. The reflection particles can include depleted uranium, uranium oxide, spent uranium oxide, or re-processed nuclear fuel. Fuel 2 can include enriched uranium 238 that includes uranium 235 or 233 tetra chloride, Uranium 235 and 233 pentafluoride, plutonium fluoride and plutonium chloride in a eutectic mixture with other molten salts, including uranium tetrafluoride. The evaporation of the molten salt controls the reactivity and the maximum temperature. Because the reactivity is controlled by the temperature, the amount of liquid fuel level can vary to accommodate different fuel reactivity, and it won't be sensitive to contamination and neutron poisons. This allows the use of re-processed fuel with long-live radioactive contaminates for fuel 2, heat transfer, reflecting and breeding in liquid 6 and for the surrounding reflector 13. The long-live thermal reactor fuel waste component will be destroyed by the intensive fast neutron radiation in the fuel 6 and the surrounding liquid 6.

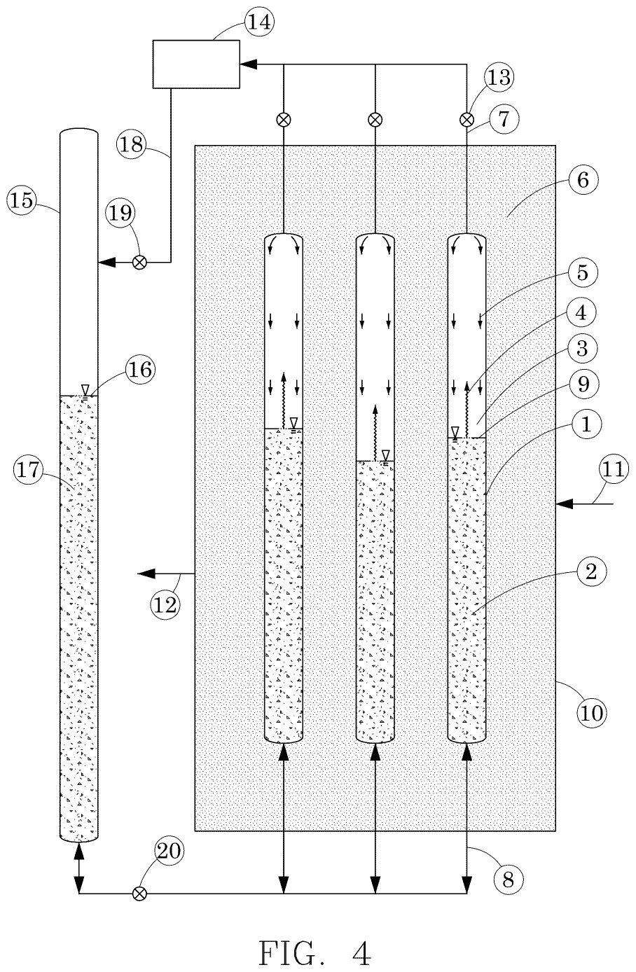

FIG. 4 shows another embodiment of the invention.

A Reactor 10 contains multiple internal longitude enclosures 1 Nuclear fuel evaporator reactor enclosures 1 located in close proximity to each other at the reactor core. Each longitude enclosure 1 can be a round tube shape and includes liquid molten fissionable salt 2. The reactor maintains its criticality and working temperature by maintaining liquid level 9. Liquid level 9 can change to adjust the reactivity and maintain the reactor working temperature which is the fuel evaporation temperature. A portion of the fissionable nuclear fuel (uranium and plutonium halogen salts) is evaluated 4 and fills the top section of fuel tube 1 with fissionable fuel vapour at the saturated temperature and pressure. The pressure in the fuel tubes is kept low close to the atmospheric temperature to reduce the structure strength requirements and increase safety by minimizing the risk of explosion. Any failure in the integrity of the reactor fuel enclosure will result in a mixture of the boiling fuel liquid phase 2 and gas phase with the surrounding liquid 6 at low pressure, so as long the heat transfer liquid won't react violently with the fuel such a complete reactor failure won't result in explosion and major risk to the surrounding as the reactor will dilute the liquid fissionable fuel 2 with the heat transfer liquid 6 and spread it within the reactor volume 10 in a non-critical manner follow by core cool-down and freezing. The heat the chain reaction generates boils the liquid nuclear fissionable fuel 2 from the liquid phase to a gas phase 3. Due to the cooling effect of the heat transfer liquid 6, the evaporated fissionable fuel 3 can condense on the internal tube walls 5 and flow down to the liquid bottom 2 while enhancing the heat transfer between the boiling fuel 2, 3 and the heat transfer cooling liquid 6. The fissionable fuel 2 can flow in and out 8 from enclosures 1 and controlled by a controller (controlled valve) 20. When the vapour pressure increases, liquid fuel will flow out from enclosure 1, reducing the reactivity. The pressure differentials are relatively low, resulting from the static liquid fuel head pressure due to the elevation difference between 9 and 16. To maintain the reactivity and the vapour pressure, fissionable salt fuel vapour with other gases produced by the nuclear reaction are released from enclosure 1 through controller 13. The pressure of the fissionable fuel gas phase is relatively low, close to atmospheric pressure, which maintains the safety of the operation, reduces the strength requirement from the structural alloys of enclosure 1 and reactor 10, and minimizes the risk of explosion. The low pressure controls the reactivity by pushing back on the liquid fuel 2, pushing excess liquid fuel 8 out of the reactor through control valve 20 and reducing the reactivity. Another reactivity control is evaporating the fissionable liquid fuel 4 and leaving 7 enclosure 2 through the control valve 13. The released gas and vapour 7 are treated in a processing facility to remove the contaminated generated gases, condense the evaporated fissionable fuel back to liquid phase 18, and recycled back through controller 19. In case controller 13 only allows a minimal amount of gas to escape from enclosure tube 1, the reactivity control will be pushing back on the liquid molten salt fuel to reduce the liquid level 9, and the reactivity, the amount of evaporate fissionable fuel will be minimized and so the recycled condensed liquid 18. The fuel level within the tubes is maintained by allowing fuel to flow in and out 8 from the enclosure from an external molten fuel container 15 that is in fluid connection with the internal critical core tubes 1. Another option to prevent oscillation is only allowing a small use of control 20. For safety operation, processing block 14 should also be capable of condensing most of the liquid fuel 2 in the reactor in case the circulating heat transfer liquid 6 stops flowing, which will result in the evaporation of a substantial amount of liquid fissionable fuel out of the reactor until the decay heat balances with the heat loss and the evaporation fuel heat. The fissionable fuel outside the reactor in block 14 and container 15 is not allowed to reach criticality by well-known structural means, including using neutron poison materials like boron, hafnium and others as structural materials and internals. Liquid fissionable fuel is added and removed from the external fuel vessel 15 to maintain the internal level 16 slightly higher than the core 10 fuel level 9 to compensate for evaporated fuel to maintain the reactivity. The colling heat transfer liquid 6 is circulated through the reactors 11, and 12 to pick up the generated heat from tube 1. The heat transfer fluid can also react as a neutron reflector and fuel breeder (in case it includes U238 or thorium) and be used to reprocess (by neutron burning) of long live radioactive contaminates from re-processed spent fuel like Actinides. Liquid 6 can include molten salt mixtures or molten liquid metals like molten lead and bismuth. To maximize the reactor's structure potential life and to allow the use of proven traditional alloys as construction materials, a fissionable fuel that evaporates at relatively low temperatures is preferred. This is particularly important for enclosures 1, which are exposed to intensive radiation and heat, and should be an efficient heat transfer to transfer the fuel 2, and 3 heat to the heat transfer liquid 6. Due to the relatively low evaporation temperature, Uranium pentafluoride and uranium tetrachloride can be used in fuel 2 with other uranium and plutonium halogen salts. This is the opposite of traditional molten salt reactors, where the evaporation of the fuel is a disadvantage, and the selected fissional fuels are selected to have a high evaporation tempered and low vapour pressure to avoid fuel evaporation.

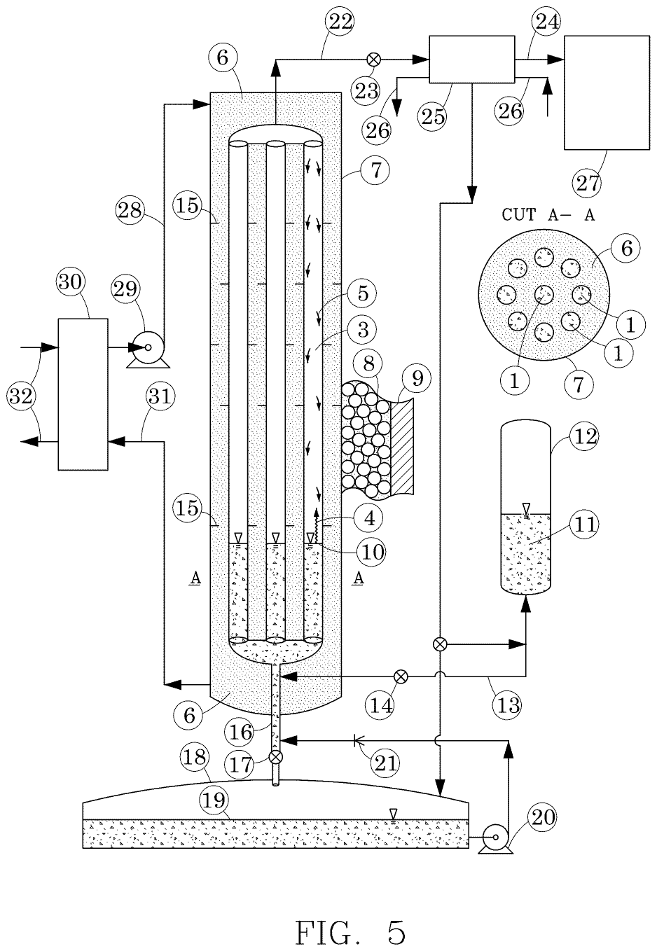

FIG. 5 shows another embodiment of the invention.

Nuclear reactor enclosure 7 includes longitude vertical enclosures 1 arranged close to each other in the center of reactor 7. The figure shows a tube-type enclosure. However, other enclosure shapes, like hexagons instead of round tubes, can also be used. The tubes are filled in their bottom with molten liquid fissionable nuclear fuel salt. The molten salt includes at least one fissionable uranium or plutonium halogen salt. Section A-A shows a schematic view of the fuel tubes 1 surrounded by heat transfer liquid 6. The schematic figure shows 9 fuel tubes. However, it is possible to use tens or even hundreds of tubes as part of the reactor design. For highly enriched fissionable fuel, less mass of liquid fuel will be needed than for lower enriched fuel. For large diameter tubes (that can contain more fissionable fuel liquid mass at their bottom), fewer, tubes will be needed to reach critically and evaporate the fissionable fuel inside the tubes 1. The heat transfer coefficient between the tubes and the internal fuel 2 and the external heat transfer liquid 6 is also a design factor in selecting the tube 1 diameter as smaller diameter fuel tubes will have a much larger heat transfer area than fewer larger tubes that contain the same amount of fissionable fuel. The reactor can include many tubes, and each tube contributes to the reactor reactivity and heat production that can be removed and recovered by cooling liquid 6. The reactor is critical when the molten salt liquid is maintained around liquid level 10. At that level, the heat generated is sufficient to evaporate 4 a portion of the fissionable liquid molten salt 2 to vapour molten salt 3. The vapour molten salt fills tube 1 above the liquid level with saturated molten salt vapour. Due to heat exchange on the tube wall, the saturated molten salt is condensed 5, transferring the evaporation heat to the tube enclosure 1wall and through the tube wall to the surrounding heat transfer liquid 6. The reactor operates at a low pressure, close to the atmospheric pressure. When the reactivity increases, heat is generated from the fissionable reaction, which evaporates liquid molten salt 2 to vapour molten salt 3. As the vapour molten salt gas phase is far less condensed than the liquid molten salt, it increases the pressure in the tubes 1, which, if not released through top discharge 22, will push down on the fissionable fuel. The fissionable fuel is allowed to flow out 13 from the critical area of the reactor to a non-critical enclosure 12 containing the fissionable molten salt fuel below criticality. The liquid level 11 in the non-critical molten salt enclosure 12 is higher or the same as the molten salt liquid level 10 inside the critical liquid fuel 2 inside tube 1. This elevation difference in the molten salt liquid column level controls the static pressure of the vapour 3 inside the tube due to the molten salt liquid column. The tubes 1 shown in the figure, are connected to each other at the bottom so the liquid molten salt can flow between the tubes. It is also possible to use independent tubes 1, which are not connected to a common collector at the bottom and is directly connected to the external accumulator non-critical tank 12. The connection 13 between the non-critical molten salt accumulator and the critical salt 2 within enclosure 1 allows flow in both directions through controller 14. When salt vapour 3 within tube 1 is condensed, the pressure drops and as a result, additional fuel will flow in through line 13 from accumulator 12 and vice versa. Control valve 14 can prevent oscillation resonance by limiting the flow and slowing the changes. The fissional fuel 2 within tubes 1 can be discharged 16 at the reactor bottom through controller valve 17 to a non-critical enclosure 18. Partial discharge can be used to collect a portion of the bottom liquid for re-processing (like removing contamination generated during the fission process, recovering fissionable fuel like plutonium and uranium that were generated in the fast reactor, and so on). The liquid level 19 and the size of the bottom tank 18 are sufficient to drain the reactor fuel without reaching criticality for shut-down or maintenance. In both reactor enclosures 12 and 18, criticality is avoided by the design of the physical layout, material use and internal that can include neutron poison like boron, hafnium and other materials to prevent criticality. Liquid molten salt fuel 19 from the bottom drain tank can be pumped 20 back through controller 21 into the reactor core tubes 1. During the reactor's operation, gases are generated and mixed with the fissionable fuel salt vapour 3. At a low level, they will not impact the performance as they boil out of the critical liquid fuel at the bottom, so even Xenon 135 will have a low impact on the criticality; however, when they accumulate over time, their partial pressure can impact the liquid fuel salt evaporation and condensation, so they should be removed. Fissionable salt vapour 3 Vapour can be released 22 through controller valve 23 To remove contamination gases and vapours (like xenon, Iodine, etc.’). The release of the fuel fissionable vapour 22 can be continued or in batches to minimize the re-processing cost. The fissionable vapour 3 released at the top is condensed 25 with cooling liquid 26. Colling liquid 26 can be the same as the working heat transfer liquid 28 or an independent colling cycle to increase redundancy and safety in case of colling pump 29 failure. The condensed fuel can be recycled back to the reactor or re-processed to recover fissionable elements and remove contaminates. The remaining non-condensed gas phase 24 includes mainly contaminates and is treated and disposed of in facility 27. For safety reasons, as a second line of defence, the vapour discharge 22 should be designed to release enough vapour 3 to prevent overpressure in the reactor tubes. The first line of defence in case of the colling cycle disturbance is that a substantial amount of fuel in the tubes 1 will evaporate and won't condense 5 at the elevated temperature. The fuel vapour 3 pressure will push the fuel from the critical area at the bottom of the tubes to the non-critical accumulator 12, reducing the criticality and heat production. In a major failure (like pump 29 or heat exchanger 30 failures), the liquid fuel can be drained to the bottom reservoir by opening drain valve 17. The reactor-generated heat is recovered by circulating liquid 6. The cooling working liquid 28 is flowing around the fuel tubes 1. The heat is recovered from the condensing 5 fissionable molten salt fuel vapour 3 and from the bottom section of the critical liquid fissionable molten salt fuel 2. The reactor can include flow deflectors 15 to enhance the heat transfer between the tubes 1 and the cooling work fluid 6. Liquid 6 can be a molten metal like lead and sodium or a non-fissionable molten salt. Liquid 6 can also be a neutron reflector and fuel breeder if the molten salt includes U238 or thorium salts. The hot liquid fluid leaving reactor 31 is recycled through heat exchanger 30, where heat is recovered to a secondary working fluid 32. The reactor cooling liquid 6 is pumped 29 and recycled back 28 to the reactor. To reduce the reactor pressure and prevent cavitation, pump 29 can be installed at the bottom close to the reactor discharge 31. The reactor heat is recovered to an external working fluid cycle 32. Reactor 7 can be surrounded by a reflecting layer 8 that can include uranium oxide packing that allows the flow of the cooling fluid 6 in between to fill up the gaps between the packing. The packing element can be spheres (as shown), cylinders, rods or any other shape. It is possible to use spent fuel for the surrounding solid cylindrical packing. Over time, the long-lived radioactive heavy isotopes will be “burned,” and plutonium will be bred from the U238 in the spent fuel. An additional passive solid or liquid reflector layer 9 can be added, and it can be made of steel, lead or any other material. To reduce the neutrons escaping the reactor reflector, it is possible to use a boron-rich layer, like encapsulated borax hydrate blocks or any other arrangement around the reactor that includes neutron poison material. To allow the usage of commercially available alloys for fuel tubes 1 and to increase their working life, the temperature in the reactor should be relatively low, lower than 1200 C. Lower temperatures provide an advantage in lower corrosion, better selection of construction materials, and longer working life at the expense of lower thermal efficiency. As the working temperature of the rector is controlled by the fissionable salt fuel boiling temperature, fissionable salts with relatively low boiling temperatures will be selected. For a chloride reactor, fissionable enriched uranium tetra chloride UCl4, or a mixture of UCl4 and UCl3, can be used with lower evaporation temperature. If a mixture of UCl4 and UCl3 is selected, it is possible to design the reactor to use a mixture of enriched uranium fuel UCl3 and depleted or natural uranium UCl4. In this arrangement, most of the fissionable U235 will always stay in a liquid form UCl3. In contrast, only a portion of the non-fissionable UCl4 will evaporate to the gas phase, pushing the liquid mixture of UCl3 and UCl4 out of the reactor center critical area to the external accumulator, reducing the reactivity. In this arrangement, the fissionable fuel portion will stay in a liquid phase with no risk of criticality in the vapours or their condensate. In addition to the uranium chloride salts, other chloride salts can be added to the fuel salt mixture. For the proposed Fluoride base molten salt reactor, Uranium Pentafluoride UF5 (or a mixture of UF5 and UF4) can be used. For the option of a mixture of UF5 and UF4, the mixture can include enriched uranium in the form of UF4 and depleted or natural uranium in the form of UF5. In this arrangement, the fission U235 will not evaporate and will stay in the liquid phase at the bottom of the enclosure. The trapped evaporated U238F5 pushes down on the enriched UF4 and UF5 mixture, which flows out of the reactivity zone in the center of the reactor to the external accumulator 12, reducing the reactivity and heat production. In addition to the uranium fluoride, additional non-fissionable fluoride salts can be included in the fuel salt mixture, like NaF, LiF, KF, BeF, ZrF, SnF2, SbF3 and BiF3.

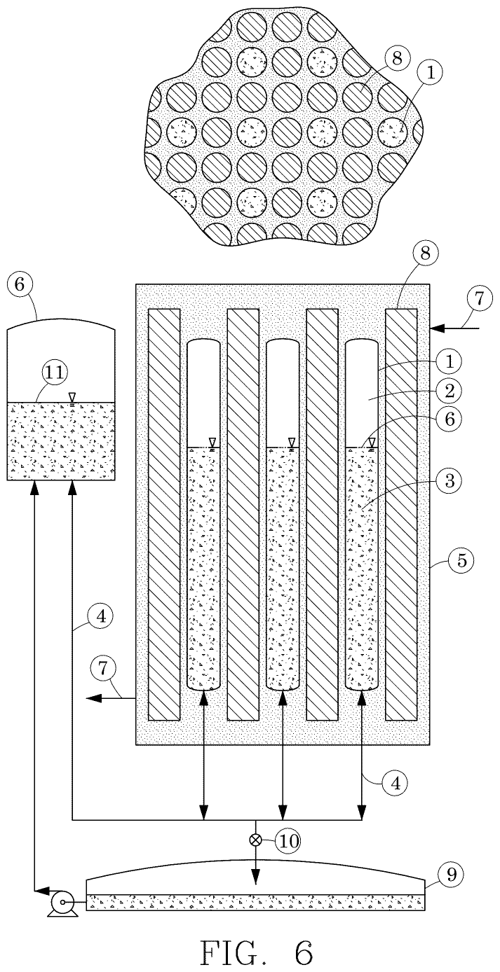

FIG. 6 shows another embodiment of the invention.

Nuclear reactor enclosure 5 includes multiple internal fuel enclosures 1. The internal fuel enclosures are partly filled with a liquid molten fissionable salt 3. Fissionable fuel 3 includes a mixture of fissionable enriched uranium and plutonium salt and non-fissionable salts that boil at a lower temperature than that of the fissionable enriched uranium or plutonium salt. The non-fission-boiled fuel vapour 2 generates pressure at the top of tube enclosure 1, pushing the liquid level down and pushing the fissionable fuel 3 out of the reactor critical area and into a non-critical accumulator tank 6. This maintains a steady state based on the saturated salt vapour temperature and pressure relation, keeping the tank's and fuel's internal temperature controlled in accordance with the boiling temperature. To allow the use of commercially available alloys for internal tubes 1, the working temperature should be relatively low, substantially lower than the UF4 boiling temperature. The evaporated salt in this arrangement doesn't have to be the fissionable uranium or plutonium salts within the mixture. Still, it can be other, non-fissionable components of the salt mixture that have lower boiling points. As an example, a fluoride-based salt mixture that contains U235F4, U233F4 and PuF4 fissionable salts fuel can include other non-fissionable elements like U238F5, ThF4, ThF5 TiF4, BeF2, SbF3, SnF2, BiF3, ZrF4, HgF, KF, NaF, LiF and others. In this molten salt mixture, non-fissionable salts will evaporate before the fissional UF4 and PuF4 evaporates. As another example, Chloride based salt fuel can include U235Cl3, U233Cl3 and PuCl3 mixed with non fissionable fertile salts like U238Cl4, ThCl4 and non-fertile salts. The trapped vapour 2 is maintained under low hydrostatic pressure because the non-critical accumulator 6 molten salt liquid level 11 is maintained higher than the liquid fuel level 6 within the critical reactor tubes 1. This trapped vapour pushes the liquid fissionable fuel 3 out of critical zone 4 and accumulator 6. When the temperature reduces, a portion of vapour 2 condenses, allowing the flow of additional fissionable fuel from accumulator 6 back to the reactor tube 3, increasing the reactivity and the heat production. Heat is recovered from the reactor with heat transfer liquid 7 that flows through the reactor. The heat transfer liquid can be a molten salt mixture or molten metal like lead, bismuth or sodium. The reactor includes reflector/breeding internals 8 arranged between fissionable fuel enclosures 1 without blocking the cooling work liquid 7 flow. The rods 8 include spent fuel with a high level of U238 and other long-lived contaminants, or thorium. Another option is to use rods 8 (or any other shape of longitudinal enclosures) that are hollow, like the fuel tubes, and filled with non-fissionable molten salt uranium or thorium with a high evaporation temperature, ensuring they will always remain in a liquid or solid form and not gas. A filling option can include U238F4, U238F3, UCl3, ThCl3, ThF4 and ThF3. Fuel 3 can be drained from the bottom of the reactor through an active or passive (melt plug) controller 10. The bottom enclosure 9 is designed to prevent criticality and with sufficient passive heat removal to prevent overheating of the drain fuel due to the radioactive decay. Vapour 2 can be drained (not shown) from enclosures 1 to remove non-condensable gas generated during the reactor operation. The reactor generates additional fissionable fuel in the reflectors 8 and in the fuel 3, and the heat transfer liquid 7 if thorium or uranium is included.

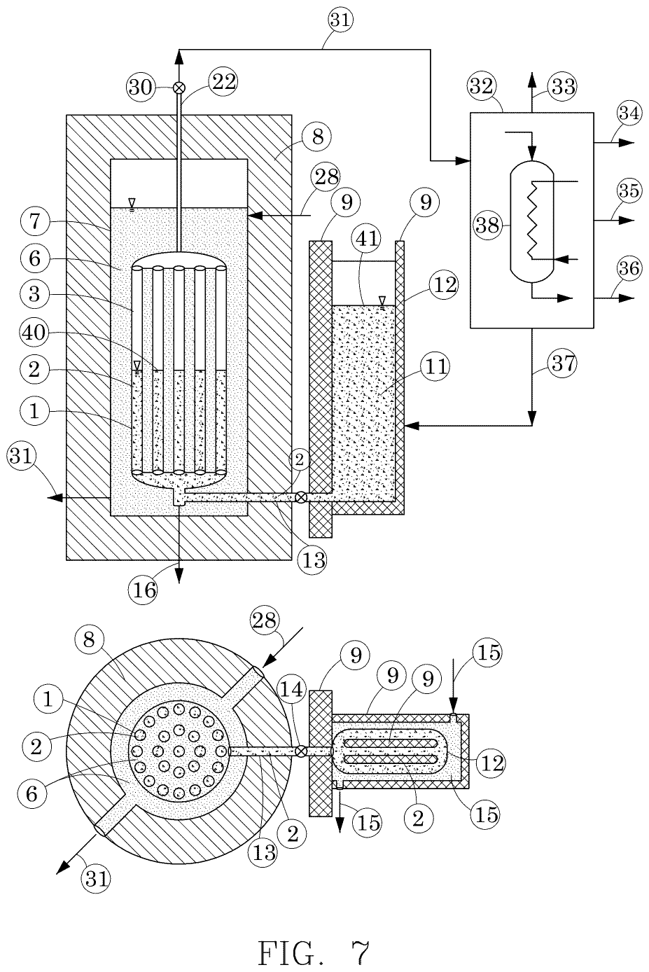

FIG. 7 shows another embodiment of the invention.

Nuclear reactor enclosure 7 includes longitudinal, vertical enclosures 1 arranged closely together in the center of reactor 7. The figure shows a tube-type enclosure. However, other enclosure shapes, like hexagons instead of round tubes, can also be used. The tubes 1 are filled at their bottom with molten liquid fissionable nuclear fuel salt. The molten salt includes at least one fissionable uranium or plutonium halogen salt. The fuel tubes 1 are surrounded by heat transfer liquid 6. For highly enriched fissionable fuel, a smaller mass of liquid fuel will be needed than for lower-enriched fuel. For large-diameter tubes (that can contain a greater mass of fissionable fuel liquid at their bottom), fewer tubes will be needed to reach criticality and evaporate the fissionable fuel inside the tubes. The heat transfer coefficient between the tubes and the internal fuel 2 and the external heat transfer liquid 6 is also a design factor in selecting the tube 1 diameter, as smaller diameter fuel tubes will have a much larger heat transfer area than fewer larger tubes that contain the same amount of fissionable fuel. The reactor can include many tubes, and each tube contributes to the reactor's reactivity and heat production, which can be removed and recovered by cooling liquid 6. The reactor is critical when the molten salt liquid is maintained at a liquid level sufficient to include sufficient fissionable fuel and the neutrons economy that depends on the core material composition and physical dimensions that can be change over time as the fuel composition change and the liquid fissionable fuel 2 mass within the core can change significantly. At the liquid criticality level, the heat generated is sufficient to evaporate a portion of the fissionable liquid molten salt 2 to vapour molten salt 3. The vapour molten salt fills tube 1 above the liquid level with saturated molten salt vapour, thereby reducing the core reactivity. Due to heat exchange on the tube wall, the saturated molten salt is condensed, transferring the evaporation heat through the tube wall to the surrounding heat transfer liquid 6. The reactor operates at a low pressure, close to the atmospheric pressure and the hydrostatic pressure due to the liquid fuel head in the fuel accumulator 12 as the fuel level in the accumulator is higher than the liquid level within the reactor to maintain the balance between the fuel liquid level and fuel gas level at the evaporation temperature and the reactivity that generate the heat. When the reactivity increases, heat is generated from the fissionable reaction, which evaporates liquid molten salt 2 to vapour molten salt 3. As the vapour molten salt gas phase is far less condensed than the liquid molten salt, it increases the pressure in the tubes 1, which pushes down on the fissionable fuel 2, reducing the level 40 by flowing liquid fuel to the accumulator enclosure 11, and accordingly, the reactor reactivity. The vapour pressure is maintained by the hydrostatic pressure due to the difference in the levels of the liquid within the critical area of the reactor tubes 40 and the liquid in the non-critical enclosure 12, which contains the fissionable molten salt fuel below criticality. The fission fuel 11 liquid level 41 in the non-critical molten salt enclosure 12 is higher than or the same as the molten salt liquid level 40 inside the critical liquid fuel 2 inside the tube 1. This elevation difference in the molten salt liquid column level controls the static pressure of the vapour 3 inside the tube due to the molten salt liquid column. The tubes 1 shown in the figure are connected to each other at the bottom, allowing the liquid molten salt to flow between them, thereby maintaining the liquid level and criticality. The connection 13 between the non-critical molten salt accumulator and the critical salt 2 within enclosure 1 allows flow in both directions through controller 14. When salt vapour 3 within tube 1 is condensed, the pressure drops and as a result, additional fuel will flow in through line 13 from accumulator 12 and vice versa. Control valve 14 can prevent oscillation resonance. If resonance becomes a problem, it can be limited by limiting the flow and slowing the changes. The fissional fuel 2 within tubes 1 can be discharged 16 at the reactor bottom to a non-critical enclosure (not shown). A freeze plug can be used to control the flow of 16. Liquid molten salt fuel, 2, 11, can be removed for reprocessing (such as removing contamination generated during the fission process, recovering fissionable fuels like plutonium and uranium generated in the fast reactor, and so on). In accumulator enclosure 12, criticality is avoided through the design of the physical layout, material use, and internal components, which can include neutron poisons such as boron, hafnium, and other materials to prevent criticality. The accumulator is separate and shielded from the reactor 9 by a neutron barrier to prevent its fuel from becoming critical or increasing the reactor's criticality. During the reactor's operation, gases are generated and mixed with the fissionable fuel salt vapour 3. At a low level, they will not impact the performance as they boil out of the critical liquid fuel at the bottom, so even Xenon 135 will have a low impact on the criticality; however, when they accumulate over time, their partial pressure can impact the liquid fuel salt evaporation and condensation, so they should be removed. Fissionable salt vapour 3 can be released through the controller valve 30 to remove contamination gases and vapours (such as xenon, Iodine, etc.). The release of the fuel fissionable vapour 22 can be continuous or in batches to minimize reprocessing costs. The fissionable vapour 3 released at the top is treated in a treatment facility 32. Radioactive gases are removed 33 for further treatment. Fissionable fuel salt vapour can be distilled at different temperatures, 33 to condense and separate valuable components like uranium salts 35, plutonium salts 34 and other salts 36 for re-use or proper disposal. Because the salts' vapours condense at different temperatures, the salts vapour mixture can be distilled in different distillers 38 temperature, which can distill different components of the evaporated fission fuel, and other products. One example of an effective breeder is the ability to continuously separate and produce pure plutonium-239 from liquid 2 or vapour 3 salt before it is irradiated further to other plutonium isotopes. Because the vapor fuel phase 3 is not chemically identical to the liquid phase 2, especially when the fuel includes a mixture of salts, it is possible to produce pure plutonium 239 isotope by continually bleed some of the liquid fuel 2, heat it externally to a higher temperature then the reactor core temperature to fully evaporate the salts and then feed the salts vapors to distillation separation facility 32 so the Pu 239 can be continually condensed and remove from the reactor before further irradiation. Instead of recovery of the plutonium by its salt condensation, it is possible to recover it chemically from the fuel by chemical separation methods. The valuable Pu239 can be used as a high-quality fuel for the start-up of other breeders or as a fuel for pressurized water reactors. As the removal of plutonium reduces the reactor reactivity, the reactor molten salt 2 includes in additional to the U238 salt also Thorium salt that will breed U233. Additional U233 and U235 can be added from external sources to compensate for the removal of the plutonium 329. The reflector 8 can include Thorium that will also breed additional U233 which can be added to the reactor core 2 to replace the continually removed Pu239. For cost-saving purposes, and if producing Pu 239 is not required, Unit 32 can be simplified to only include removing the contaminated gases 33 and recycling the condensed salt vapour 37 back into the reactor. For safety reasons, as a second line of defence, the vapour discharge 22 should be designed to release enough vapour 3 to prevent overpressure in the reactor tubes. The reactor's natural normal control and first line of defence in case of the cooling cycle disturbance is that a substantial amount of liquid fuel 2 in the tubes 1 will evaporate 3 at the elevated temperature. The fuel vapour 3 pressure will push the fuel from the critical area in the reactor center tubes to the non-critical accumulator 12, reducing the criticality and heat production. The liquid fuel can be drained to the bottom of the reactor 16. The reactor-generated heat is recovered by circulating liquid 6, 28, 29. The cooling working liquid 6 is flowing around the fuel tubes 1. The heat is recovered from the liquid 2 and vapour 3 fissionable molten salt fuel. Heat transfer Liquid 6 can be a molten metal, such as lead and sodium, a breedable molten salt that includes U238 or thorium salts, and a passive molten salt mixture. Liquid 6 can also serve as a neutron reflector and fuel breeder if the molten salt contains U238 or thorium salts. The reactor heat transfer liquid 6 is pumped 29 and recycled back 28 to the reactor. The reactor heat is recovered to an external heat exchanger (not shown). Reactor 7 can be surrounded by a reflecting layer 8 that can include a breedable element of thorium and U-238. The reflecting and breedable enclosure surrounding the reactor can be composed from solid uranium or thorium elements or liquid thorium and uranium salt that is maintained in a molten salt liquid phase due to the reactor heat and are design to have evaporation temperature equal or higher than the fuel salt evaporation temperature as to always remain in a liquid form. The produced fissionable fuel can be recovered from the reflecting breedable layer 8 and used as a fuel. The reflecting layer 8 can include uranium or thorium oxide elements, including reprocessed spent fuel. It is possible to use spent fuel packing. Over time, the long-lived radioactive heavy isotopes within the spent fuel will be “burned,” and plutonium will be bred from the U238 in the spent fuel. An additional passive solid or liquid reflector layer can be added (not shown), and it can be made of steel, lead or any other material. To reduce the neutrons escaping the reactor reflector, it is possible to use a boron-rich layer, like encapsulated borax hydrate blocks or any other arrangement around the reactor that includes neutron poison material. To allow the use of commercially available alloys for fuel tubes 1 and to increase their working life, the temperature in the reactor should be lower than 1200 °C. Lower temperatures offer advantages in reduced corrosion, improved selection of construction materials, and extended working life, albeit at the expense of lower thermal efficiency. As the working temperature of the reactor is controlled by the fissionable salt fuel boiling temperature, fissionable salts with relatively low boiling temperatures will be selected.

For a chloride-based reactor, fissionable enriched uranium tetra chloride UCl4, or a mixture of UCl4 and UCl3, can be used with a lower evaporation temperature. If a mixture of UCl4 and UCl3 is selected, it is possible to design the reactor to use a mixture of enriched uranium fuel, UCl3 and depleted or natural uranium, UCl4. In this arrangement, most of the fissionable U-235 or U-233 will always remain in a liquid form as UCl3. In contrast, only a portion of the non-fissionable UCl4 will evaporate into the gas phase, pushing the liquid mixture of UCl3 and UCl4 out of the reactor's critical area to the external accumulator, thereby reducing reactivity. In this arrangement, the fissionable fuel portion will stay in a liquid phase with reduced risk of criticality in the vapours or their condensate. In addition to the uranium chloride salts, other chloride salts can be added to the fuel salt mixture like NaCl, LiCl, KCl, BeCl2, SnCl2, BiCl3 and others. One option is to include passive non-fissionable chloride salts which have lower evaporation temperature (like SnCl2, BiCl3 and BeCl3 for example) which can evaporate and push on the molten uranium or plutonium molten salts that will remain in liquid form 2 in the reactor tubes 1 and the accumulator 11.

For a fluoride-based molten salt reactor, uranium pentafluoride (UF5) or a mixture of UF5 and UF4 can be used. For the option of a mixture of UF5 and UF4, the mixture can include enriched uranium in the form of UF4 and depleted or natural uranium in the form of UF5. In this arrangement, the fission U235 or U233 will not evaporate and will stay in the liquid phase at the bottom of the enclosure. The trapped evaporated UF5 pushes down on the enriched UF4 and UF5 mixture, which flows out of the reactivity zone in the center of the reactor to the external accumulator 12, reducing the reactivity and heat production. In addition to uranium fluoride, other non-fissionable fluoride salts can be included in the fuel salt mixture, such as NaF, LiF, KF, BeF2, ZrF4, SnF2, SbF3, BiF3, and others. Some of the non-fissionable fluoride salts which have lower evaporation temperature (like SnF2, BiF3 and SbF3 for example) can evaporate before the uranium or plutonium salts evaporates and control the maximum core temperature by converting to gas and pushing down on the fissionable fuel molten salt mixture away from the reactor critical center 1 and into the accumulator 11. For this option, the amount of useful fissionable salts in vapour 22 will be low. Accordingly, unit 32 will be simplified to condense the vapour and remove the non-condensable radioactive gases 33. The condensed salt vapour 37 can be directed to the reactor tubes 1 (not shown) and not to the accumulator 12 as shown 37, to prevent removal of the low-temperature condensing salt from the reactor 1 and its accumulation in the accumulator 12—the same applies to chlorine-based salts as well. The reactor can maintain its reactivity for a changing fuel reactivity by adjusting its geometry and increasing reactivity by filling the tubes with more fuel from the accumulator, and vice versa. For less reactive fuel due to a low percentage of fissionable uranium and plutonium, or if the amount of waste materials and neutron poison increases, additional fissionable liquid molten salt fuel will flow from the non-critical accumulator to the reactor. Another option is to use liquid fuel 2, which includes UF4, PuF4, and PuF3, along with additional passive fluoride salts that reduce the melting point of the salt mixture and at least one passive salt with a lower evaporation temperature (such as SnF2, BiF3, and SbF3, for example). The vapour 3, which controls the reactivity and pushes the fissionable plutonium and Uranium down the tubes and away from the critical reactor area to the accumulator 11, does not contain fissionable salt vapour but the passive salt with a lower evaporation temperature. A small amount of this vapour can be removed from the reactor 22 for contaminant removal and circulated back to the tubes 1.

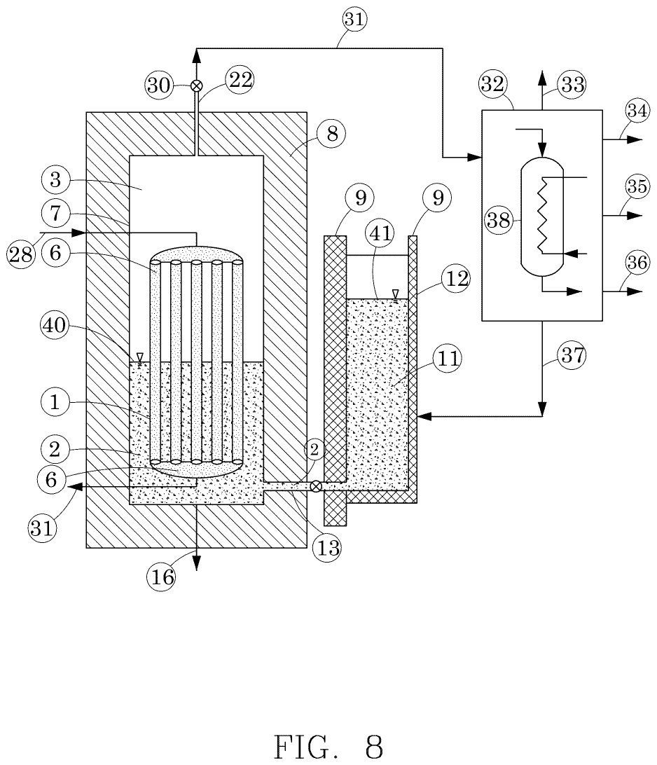

FIG. 8 shows another embodiment of the invention.

In FIG. 8, the molten salt fuel 2 is not maintained within the tubes but outside in the reactor enclosure 7. The fissionable molten salt is maintained at a critical level 40 by molten salt vapour 3 that pushes on the liquid level 40 into an external accumulator 12 with a higher level of molten salt fuel 11. The composition of the molten salt fuels 2 and 11 is substantially similar. The reactor features an internal heat exchanger with tubes. Heat transfer liquid that can be a liquid metal, or non-fissionable molten salt 6, is flowing 28, 31 through the internal heat transfer. The fissionable fuel 2 is surrounded by a reflector 8 that can include solid or liquid U238 or Thorium to breed additional fissionable fuel. Main difference between FIGS. 7 and 8 is that in FIG. 8 the tubes 1 contains the heat transfer liquid, and the fissionable fuel 2 surrounding them while in FIG. 7 it is the opposite.

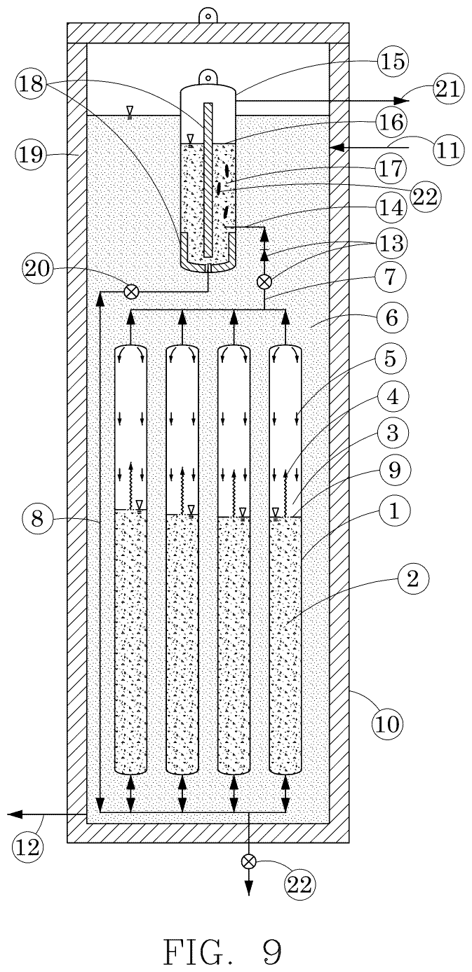

FIG. 9 shows another embodiment of the invention.

Nuclear reactor enclosure 10 includes longitudinal, vertical enclosures 1 arranged closely together in the center of the reactor. The figure shows a tube-type enclosure. However, other enclosure shapes, like hexagons instead of round tubes, can also be used. The tubes 1 are filled at their bottom with molten liquid fissionable nuclear fuel salt. The molten salt includes at least one fissionable uranium and plutonium salt. The reactor is critical when the level of the liquid fissionable fuel reaches a certain level, 9, which depends on many factors, mainly the fuel reactivity and the reactor geometry and reflecting. Level 9 can vary significantly to maintain the reactor critical at a wide range of fuel reactivity, neutron poison, and other factors. The molten salt fuel 2 can include a fluoride-based or chlorine-based fissionable salt. The fuel salt or portion of it evaporates 3 at a certain temperature and pushes on the liquid 2. The liquid 2 flows 8 through a liquid flow controller 20 to the accumulator 15. The accumulator is located at a higher elevation of the reactor to maintain low hydrostatic pressure, which is a result of level 16 being higher than level 9. The vapour 3 is kept under this hydrostatic low pressure. As the reactivity decreases, a portion of the fuel gas 3 condenses and reduces the volume, allowing for an increase in the fuel flow into the reactor 8, increasing its reactivity. The opposite happened when the temperature increases, liquid fuel evaporates, 4 increasing the pressure of vapour 3 and pushing liquid fuel 2 from the reactor to the accumulator 15. The accumulator 15 separates the fissionable liquid inside it from increasing the reactor reactivity by neutron shield and internals 18 that block neutrons and prevent criticality inside the accumulator 15. Vapor and other contaminate gases 3 are released 7 through controller 13 and flowing into the accumulator liquid section where the vapor 14 are condensed directly to the accumulator molten salt 17. The contaminated non-condensed gases are accumulated above the liquid molten fuel salt and are removed 21 for treatment and disposal when their radioactivity decreases to an acceptable level. The accumulator pressure is always maintained at a low level, close to atmospheric pressure. Heat is recovered by a surrounding liquid 6, which can include liquid metal or molten salt. The heat-transfer molten salt 6 can include breedable uranium or thorium salts and is circulated 11, 12 through the reactor, collecting heat from the critical fuel within the tubes 1. The molten salt fuel can be drained from the tubes by the controller or frozen plug 22. The internals, which include the critical section 1 and the accumulator, are modular and removable, allowing them to be pulled out for replacement. The reactor enclosure 19 includes a neutron reflector, possibly with breeding elements that include U238 or thorium, which produces additional fissionable fuel.

1. A system for a molten salt-fast neutron reactor, comprising:
a reactor core being comprised of a multiple elongated enclosures filled with a fissionable molten salt fuel,
wherein the molten salt fuel comprises a liquid phase at the bottom of the enclosures and a vapour phase at the top of the enclosures,
wherein the amount of fissionable molten salt liquid phase generates criticality and heat to evaporate the fuel;
wherein the fissionable molten salt fuel that evaporates and is maintained in a saturated temperature inside the elongated enclosures, the fissionable molten salt being comprised of at least one of uranium pentafluoride, uranium tetrafluoride uranium tetra chloride, uranium trichloride plutonium pentafluoride, plutonium tetrafluoride, plutonium tetra chloride and plutonium trichloride salts;
a connection at the bottom of the elongated enclosures allows a controlled flow of liquid fissionable molten salt fuel in and out of the elongated enclosures;
a connection at the top of the elongated enclosures allows a controlled gas flow out of the elongated enclosures; and
a non-fissionable heat transfer liquid flows around the multiple elongated enclosures and recovers heat from the enclosure's.

2. A method for a nuclear fast reactor, comprises the following steps:
installing multiple enclosures in close proximity to each other in the reactor core;
partly filling the multiple enclosures with liquid fissionable fuel containing molten fissionable halogenate salt;
reaching reactivity and generating heat while evaporating a portion of the fissionable liquid fuel from a liquid phase to a vapor phase while reducing the reactivity and heat production;
recovering heat from the multiple enclosures walls to a sounding heat transfer liquid;
collecting the evaporated fissionable fuel vapor phase;
condensing the evaporated fissionable fuel vapor to a liquid phase and removing contaminate radioactive non-condensable gases; and
recycling portion of the liquid phase condensed fissionable fuel vapor back to the partly filled multiple enclosures to increase the reactor reactivity.

3. A method for a nuclear fast reactor, comprises the following steps:
installing multiple parallel longitude enclosures in close proximity to each other in the reactor core;
installing an accumulator separated from the reactor core, where the accumulator bottom is fluidly connected to the bottom of the multiple enclosures, allowing a liquid flow between the two where the accumulator design liquid level is higher then the liquid level in the multiple enclosures;
partly filling the multiple enclosures and the accumulator with liquid molten fissionable fuel containing molten fissionable halogenate salt;
reaching criticality and increase reactivity with the partly filled multiple enclosures and generating heat while evaporating portion of the fissionable liquid fuel from a liquid phase to a vapor phase within the multiple enclosures;
trapping a portion of the fissionable fuel vapour at the multiple enclosures top sections and allowing the pressure to increase and push down on the molten liquid salt against the hydrostatic head due to the higher liquid level within the accumulator;
allowing the molten liquid salt in the enclosures to flow to the accumulator, reducing the reactor reactivity and heat production while increasing the accumulator fluid level above the level of liquid level within the multiple enclosures to balance the hydrostatic pressure and the vapour pressure;
with the reduced reactivity, condensing portion of the trapped vapour within the enclosure top section from vapour to liquid while reducing the pressure within the multiple enclosures and allowing the hydrostatic pressure from the higher liquid level within the accumulator to flow liquid molten salt back from the accumulator to the enclosures while increasing the reactivity and heat production;
removing at least a portion of the trapped vapour within the enclosure top to remove contaminate radioactive gas;
circulating heat transfer liquid around the multiple enclosures to transfer heat from the enclosure walls; and
recovering the heat for steam production.

4. The system of claim 1, wherein
the reactor longitude enclosures are in a pipe shape and are connected together at their bottom and top into a bundle.

5. The system of claim 1, further comprising:
an accumulator enclosure partly filled with a fissionable molten salt fuel liquid fluidly connected to the reactor longitude enclosures bottom for allowing a controlled flow of fissionable molten salt fuel liquid in an out of the reactor to increase and decrease the reactor reactivity and heat production.

6. The system of claim 1,
wherein the non-fissionable heat transfer liquid is contain material selected from the following group: lead, sodium, uranium 238 molten halogen salt and thorium molten halogen salt.

7. The system of claim 4, further comprising:
a neutron reflector and a breeder surrounding the reactor fuel pipe, wherein the neutron reflector and breeder contains at least one of: solid U238, solid thorium, molten U238 halogen salt and molten thorium halogen salt.

8. The method of claim 2, wherein the fissionable molten salt comprises at least one of uranium pentafluoride, uranium tetrafluoride uranium tetra chloride, uranium trichloride, plutonium pentafluoride, plutonium tetrafluoride, plutonium tetra chloride and plutonium trichloride salts.

9. The method of claim 8, wherein the reactor longitude enclosures are in a pipe shape and are connected together at their bottom and top.

10. The method of claim 8, wherein the surrounding heat transfer liquid contains at least one of lead, sodium, uranium 238 molten halogen salt and thorium molten halogen salt.

11. The method of claim 9, wherein the reactor longitude pipes are surrounded by a combined neutron reflector and breeder contains at least one of: solid U238, solid thorium, molten U238 halogen salt and molten thorium halogen salt.

12. The method of claim 11, wherein at least one of plutonium and U233 is recovered from the reflector.

13. The method of claim 3, wherein the liquid phase of the fissionable molten salt comprises at least one of uranium pentafluoride, uranium tetrafluoride uranium tetra chloride, uranium trichloride, plutonium pentafluoride, plutonium tetrafluoride, plutonium tetra chloride and plutonium trichloride salts.

14. The method of claim 3, wherein the vapour phase of the fissionable molten salt comprises a passive non-fissionable molten salt vapour with a lower condensing temperature.

15. The method of claim 3, wherein the fluid connection between the longitude enclosures and the accumulator is controlled by a valve.

16. The method of claim 3, wherein the removing at least a portion of the trapped vapour within the enclosure top to remove contaminate radioactive gas is control by a valve which maintain the hydrostatic pressure generated by the accumulator higher molten salt liquid level.

17. The method of claim 3, wherein the reactor longitude enclosures are in a pipe shape and are connected together at their bottom and top.

18. The method of claim 17, wherein the surrounding heat transfer liquid contains at least one of lead, sodium, uranium 238 molten halogen salt and thorium molten halogen salt.

19. The method of claim 18, wherein the reactor longitude pipes are surrounded by a combined neutron reflector and breeder contains at least one of: solid U238, solid thorium, molten U238 halogen salt and molten thorium halogen salt.

20. The method of claim 3, wherein the fissional fuel contains U238, thorium, U233 and plutonium, the method further comprising the steps of:
recovering the produce Pu239 and
replacing the Pu239 with the fissionable U233 produced from the thorium to compensate for the removed plutonium and maintain the reactor reactivity.
